(19) United States
(12) Patent Application Publication
(10) Pub. No.: US 2012/0062463 A1
(43) Pub. Date: Mar. 15, 2012

(54) TOUCH SENSING APPARATUS FOR GENERATING TOUCH SENSING RESULT ACCORDING TO DIFFERENTIAL SIGNAL OF MUTUAL CAPACITANCE TRIGGERED BY TOUCH EVENT

(76) Inventors: Tung-Ke Wu, Taipei City (TW); Ching-Hsiang Chang, Yilan County (TW)

(21) Appl. No.: 13/226,506

(22) Filed: Sep. 7, 2011

(30) Foreign Application Priority Data
Sep. 13, 2010 (TW) 099130925

(51) Int. Cl. G06F 3/041; G06F 3/02

(52) U.S. Cl. 345/168; 345/173

(57) ABSTRACT

A touch sensing apparatus includes at least one sensing key and a processing circuit. Each of the sensing key includes a signal receiving component for receiving a driving signal, a first sensing block and a reference block. The first sensing block is coupled to the signal receiving component, and arranged to generate a first sensing signal according to a touch event and the driving signal. The reference block is coupled to the signal receiving component, and arranged to generate a reference signal according to the touch event and the driving signal. The processing circuit is coupled to the sensing key, and arranged to provide the driving signal and receive the first sensing signal and reference signal, generate a sensing output of the sensing key according to the reference signal and first sensing signal generated by the sensing key, and generate the touch sensing result according to the sensing output.

### BACKGROUND OF THE INVENTION

1. Field of the Invention

The disclosed embodiments of the present invention relate to touch control technology, and more particularly, to a touch sensing apparatus for generating a touch sensing result according to a differential signal of mutual capacitance triggered by a touch event.

2. Description of the Prior Art

Due to the growing popularity of regular electronic handheld device (e.g. smart phones, handheld media player, etc.), the market demand of related sensing device based on a sensing key, e.g. a contact bar or a contact ring, is increasing as well. A common sensing key uses self-inductive or mutual-inductive capacitance to detect a touch event. Compared to mechanical input device, the self-inductive or mutual-inductive capacitance sensing key has certain advantages, such as compact size, low cost, etc. However, regular self-inductive or mutual-inductive sensing keys only employ intrinsic capacitance of a sensing electrode to determine whether there is a touch event or not. When the environment is filled with excessive unrelated signals or there is electronic noise in the system, variation of the intrinsic capacitance of the sensing electrode will be effected by the noise, leading to an incorrect touch event decision. Therefore, how to remove electronic noise in a sensing key related device to provide an easy and correct touch sensing result is still a problem to be solved in this pertinent field.

### SUMMARY OF THE INVENTION

In accordance with exemplary embodiments of the present invention, a touch sensing apparatus capable of generating a touch sensing result according to a differential signal of mutual capacitance triggered by a touch event is proposed to solve the above-mentioned problem.

According to one embodiment of the present invention, a touch sensing apparatus for generating a touch sensing result according to a touch event is disclosed. The touch sensing apparatus includes at least one sensing key and a processing circuit. Each of the at least one sensing key includes a signal receiving component, a first sensing block and a reference block. The signal receiving component is only used for receiving a driving signal. The first sensing block is coupled to the signal receiving component, wherein the first sensing block is arranged to generate a first sensing signal according to the touch event and the driving signal. The reference block is coupled to the signal receiving component, wherein the reference block is arranged to generate a reference signal according to the touch event and the driving signal. The processing circuit is coupled to the sensing key, and arranged to provide the driving signal and receive the first sensing signal and the reference signal, generate a sensing output of the sensing key according to at least the reference signal and the first sensing signal generated by the sensing key, and generate the touch sensing result according to at least the sensing output.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a touch sensing apparatus according to an embodiment of the present invention.

FIG. 2 is a schematic diagram of a sensing key in the touch sensing apparatus shown in FIG. 1.

FIG. 3 is a schematic diagram of a touch sensing apparatus according to another embodiment of the present invention.

FIG. 4 is a schematic diagram of an application using the touch sensing apparatus shown in FIG. 3 to determine a contact direction of a touch event according to an embodiment of the present invention.

FIG. 5 is a schematic diagram of a touch sensing apparatus according to another embodiment of the present invention.

FIG. 6 is a schematic diagram of a touch sensing apparatus according to another embodiment of the present invention.

FIG. 7 is a schematic diagram of a touch sensing apparatus according to another embodiment of the present invention.

FIG. 8 is a schematic diagram of a touch sensing apparatus according to another embodiment of the present invention.

FIG. 9 is a schematic diagram of a touch sensing apparatus according to another embodiment of the present invention.

### DETAILED DESCRIPTION

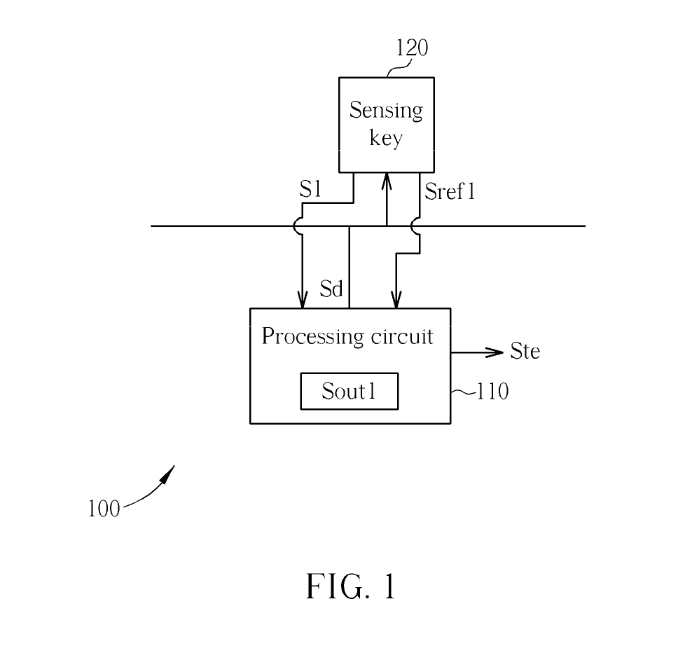

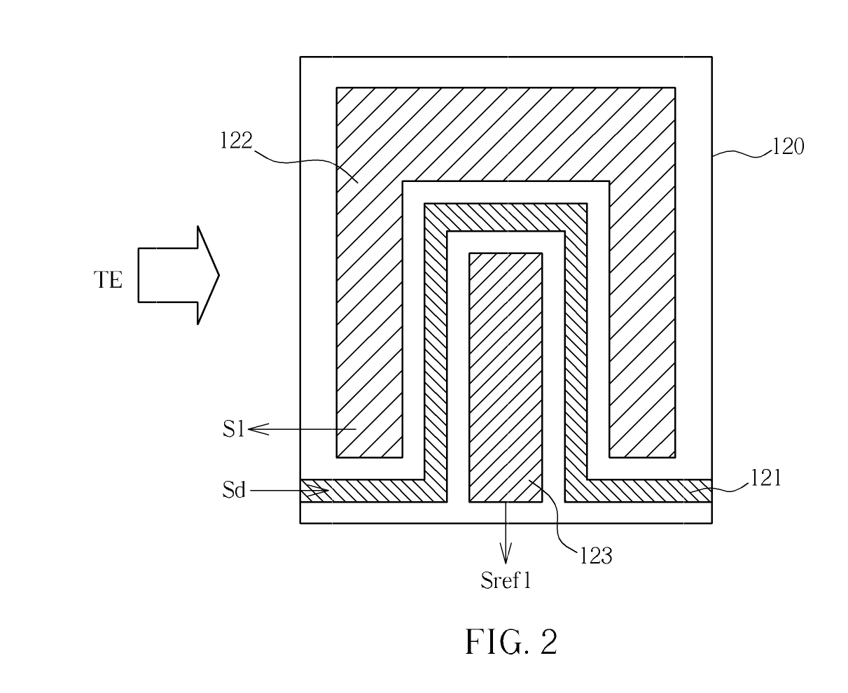

Please concurrently refer to FIG. 1 and FIG. 2. FIG. 1 is a schematic diagram of a touch sensing apparatus 100 according to an embodiment of the present invention, and FIG. 2 is a schematic diagram of a sensing key 120 in the touch sensing apparatus 100 shown in FIG. 1. The touch sensing apparatus 100 includes a processing circuit 110 and at least one the sensing key 120. In this embodiment, only one sensing key is shown in FIG. 1 for illustrative purposes; however, in practice, the present invention is not limited to the number of sensing keys employed by the touch sensing apparatus. That is, the number of sensing keys can be determined based on design consideration. The sensing key 120 includes a signal receiving component 121, a first sensing block 122 and a reference block 123. The signal receiving component 121 in this embodiment is only used for receiving a driving signal Sd, and the first sensing block 122 generates a first sensing signal S1 according to a touch event TE (e.g., user's finger touching the sensing key 120) on the touch sensing apparatus 100 and the driving signal Sd, and the reference block 123 also generates a reference signal Sref1 according to the touch event TE and the driving signal Sd. In addition, the processing circuit 110 provides the driving signal Sd and receives the first sensing signal S1 and the reference signal Sref1, generates a sensing output Sout1 of the sensing key 120 according to the reference signal Sref1 and the first sensing signal S1 generated from the sensing key 120, and generates a touch sensing result Ste according to at least the sensing output Sout1. For example, when a user uses his/her finger to press the sensing key 120, voltage values of the first sensing block 122 and the reference block 123 would be altered, and the processing circuit 110 concurrently generates the driving signal Sd to the first sensing block 122 and the reference block 123, and processes the first sensing signal S1 and the reference signal Sref1 respectively generated by the first sensing block 122 and the reference block 123. For example, the processing circuit 110 uses the reference signal Sref1 as a reference to calibrate/adjust the first sensing signal S1, and accordingly generates the sensing output Sout1 of the sensing key 120. In other words, Sout=S1−Sref1. Even if the signals S1 and Sref1 generated from the sensing key 120 have errors due to noise, the impact of the errors can be lowered or eliminated by a differential operation. However, the above-mentioned operation merely illustrates an embodiment of the present invention, and is not meant to be limitations of the present invention. For example, the sensing output Sout1 can be generated by using the first sensing signal S1 as the reference to calibrate/adjust the reference signal Sref1. Such an alternative design also falls within the scope of the present invention.

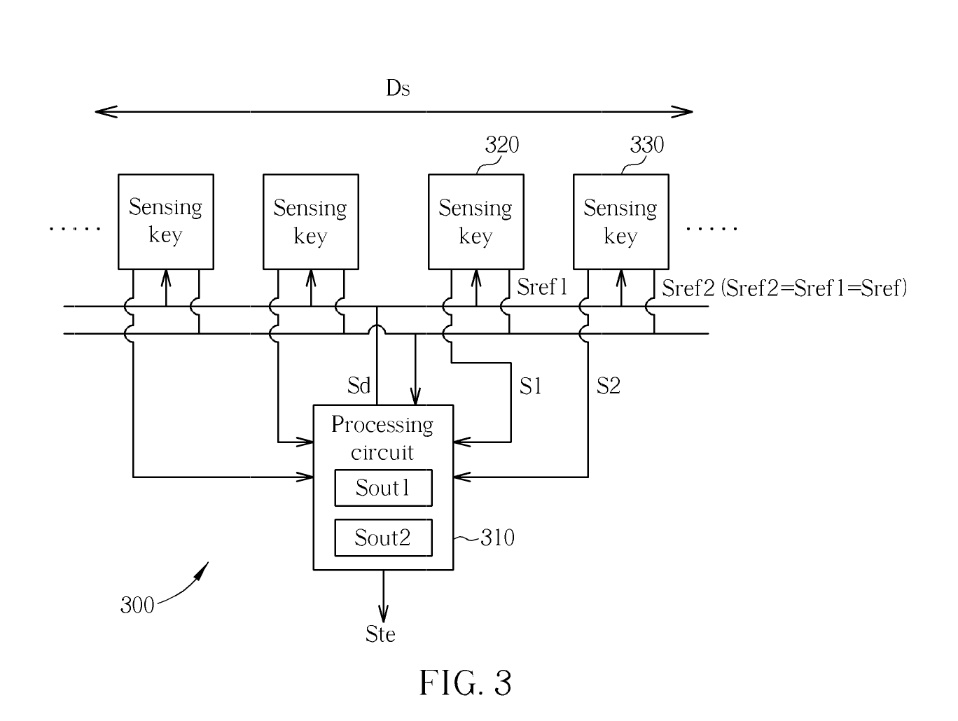

Please refer to FIG. 3, which is a schematic diagram of a touch sensing apparatus 300 according to another embodiment of the present invention. The touch sensing apparatus 300 includes a processing circuit 310 and a plurality of sensing key, including at least the sensing keys 320 and 330, arranged in a same predetermined direction DS, wherein the functions and structures of the processing circuit 310 and the sensing keys 320, 330 are substantially the same as the processing circuit 110 and the sensing key 120 shown in FIG. 1, respectively, and related description is therefore omitted here for brevity. Similarly, 4 sensing keys are shown in FIG. 3 for illustrative purposes; however, in practice, the present invention is not limited to the number of sensing keys employed by the touch sensing apparatus. That is, the number of sensing keys can be determined based on design consideration. In addition, the predetermined direction DS from left to right (or from right to left) in FIG. 3 is a straight line direction; however, this is for illustrative purposes only, and not meant to be limitations of the present invention. The sensing keys 320 and 330 respectively receive corresponding driving signals to generate corresponding sensing signals and reference signals according to a touch event. However, in order to simplify the illustration, in this embodiment, the sensing keys 320 and 330 share the same driving signal Sd and the same reference signal Sref. In other words, signal receiving components of the sensing keys 320 and 330 are coupled together and also coupled to the processing circuit 310, and respective reference blocks are also coupled together for transmitting the reference signal Sref (Sref=Sref1=Sref2) to the processing circuit 310. Therefore, the sensing keys 320 and 330 transmit the sensing signals S1 and S2 to the processing circuit 310, and the processing circuit 310 generates the sensing outputs Sout1 and Sout2 respectively corresponding to the sensing key 320 and 330 according to the sensing signals 51, S2 and the reference signal Sref. For example, Sout1=S1−Sref and Sout2=S2−Sref. Please note that, the above-mentioned embodiment is for illustrative purposes only, and not meant to be limitations of the present invention.

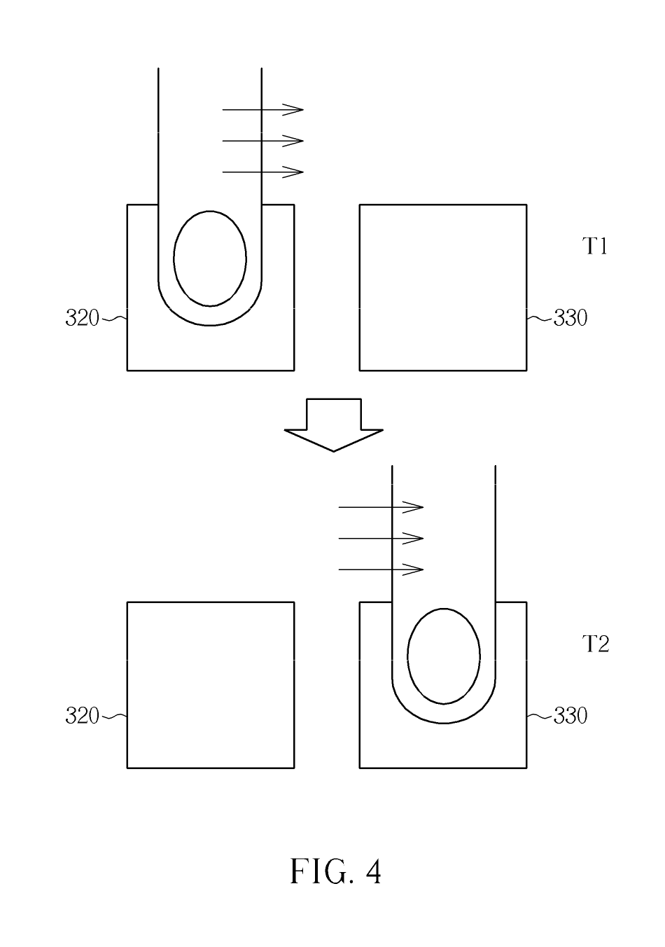

After the sensing outputs Sout1 and Sout2 are obtained, the processing circuit 310 can determine a contact direction and a contact position of the touch event TE according to relative changes of the sensing outputs Sout1 and Sout2. Please refer to FIG. 4, which is a schematic diagram of an application using the touch sensing apparatus 300 to determine a contact direction of the touch event TE according to an embodiment of the present invention. At a time point T1, a user uses a finger to press the sensing key 320 (i.e. the sensing key 320 has the touch event TE occurring thereon), and starts moving his/her finger in the predetermined direction DS (e.g. a straight-line direction from left to right) to move the finger toward right, wherein the magnitude of the sensing output Sout1 indicates a contact of the finger. At the next time point T2, if the user's finger is moved to another sensing key 330, variations of the sensing outputs Sout1 and Sout2 between the time points T1 and T2 would indicate that the touch event TE triggered by the user is moving from left to right, and thus the processing circuit 310 can determine that the contact direction of the touch event TE is from left to right.

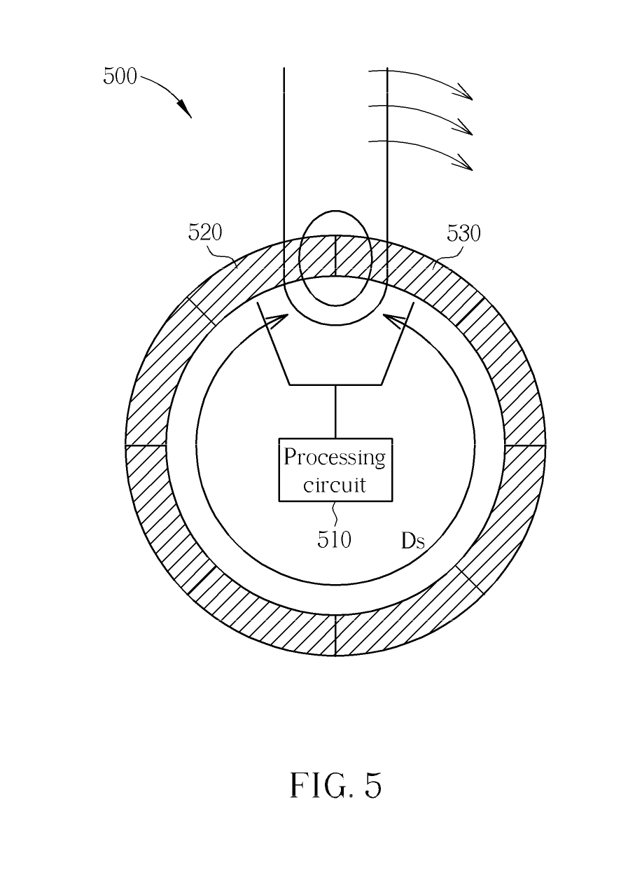

Please refer to FIG. 5, which is a schematic diagram of a touch sensing apparatus 500 according to another embodiment of the present invention. Functions and structures of the touch sensing apparatus 500 are substantially the same as the touch sensing apparatus 300 shown in FIG. 3, and related description is therefore omitted here for brevity. The difference between the touch sensing apparatuses 500 and 300 is that the sensing keys 520 and 530 of the touch sensing apparatus 500 are arranged clockwise (or counterclockwise). That is, the predetermined direction DS is a clockwise (or counterclockwise) direction. Thus, when the user triggers the touch event TE on the touch sensing apparatus 500, a processing circuit 510 would determine whether the direction of the touch event TE is a clockwise direction or a counterclockwise direction according to variations between the related sensing outputs Sout1 and Sout2.

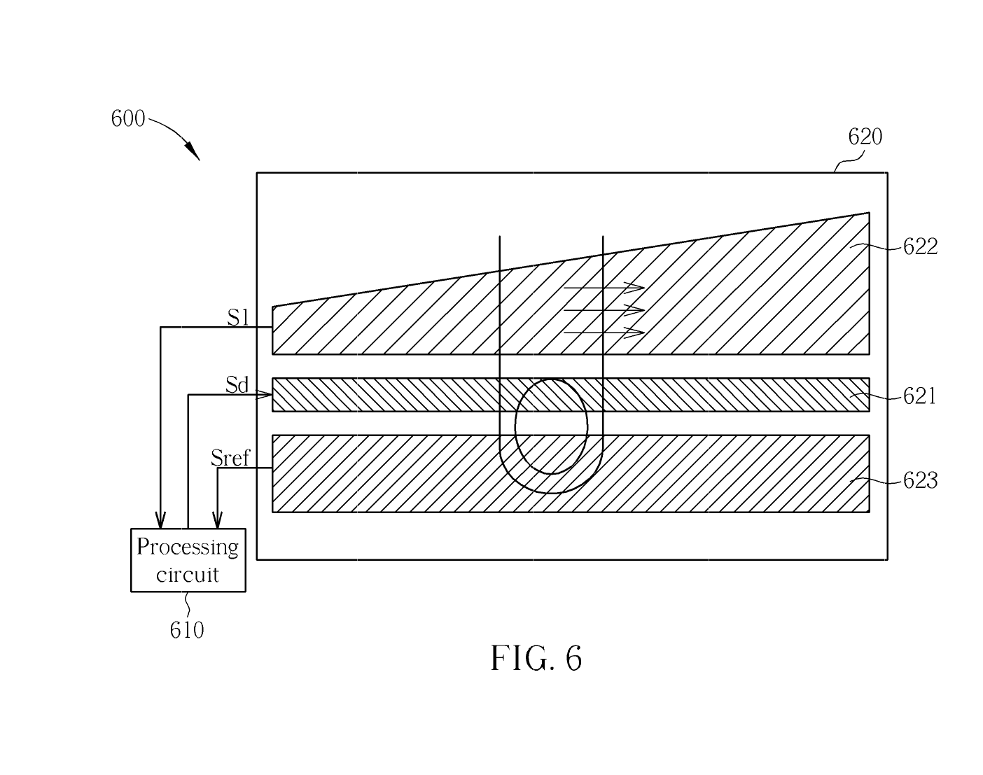

Another embodiment of the present invention refers to the contact area size of a single key to determine a contact direction of the touch event TE. Please refer to FIG. 6, which is a schematic diagram of a touch sensing apparatus 600 according to another embodiment of the present invention. The difference between the aforementioned touch sensing apparatus 300 and the touch sensing apparatus 600 is that the touch sensing apparatus 600 includes a processing circuit 610 and a single the sensing key 620 only, wherein functions and structures of the processing circuit 610 and the processing circuit 310 shown in FIG. 3 are substantially the same, and related description is therefore omitted here for brevity. The sensing key 620 includes a signal receiving component 621, a first sensing block 622 and a reference block 623, and the first sensing block 622 has different sensing areas in a predetermined direction (e.g. straight line direction) of the touch sensing apparatus 600. In this embodiment, the sensing area in a vertical direction of the first sensing block 622 gradually increases from a first side to a second side (e.g. from left to right). Therefore, when the user uses a finer to swipe on the sensing key 620, the processing circuit 610 would determine a contact direction of the touch event TE according to the magnitude and variation of the received sensing output Sout. After being precisely calibrated, the processing circuit 610 can locate the position of the touch event TE according to the magnitude of sensing output Sout.

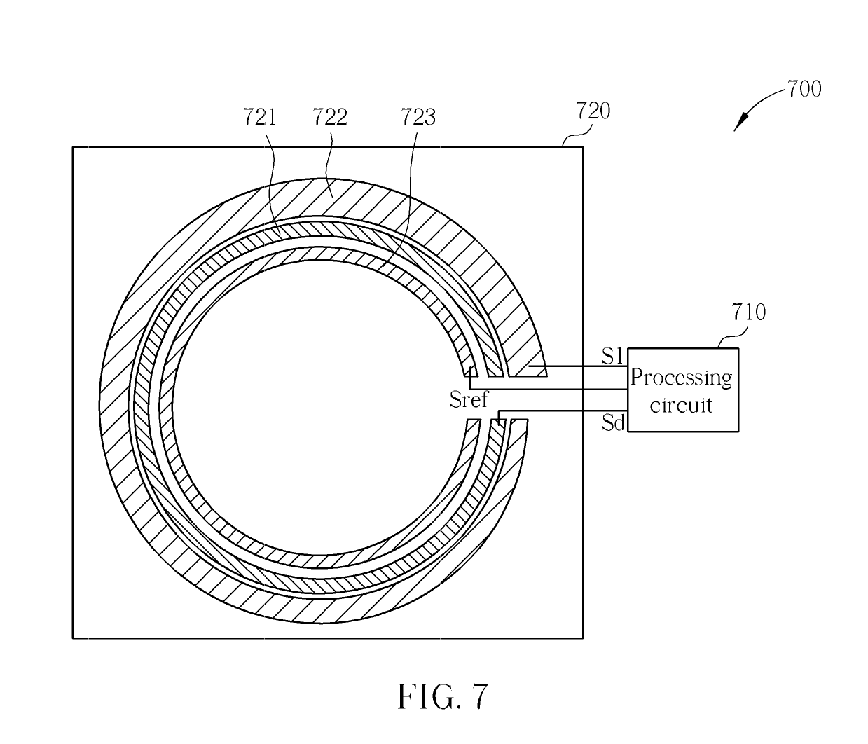

Please refer to FIG. 7, which is a schematic diagram of a touch sensing apparatus 700 according to another embodiment of the present invention. Functions and structures of the touch sensing apparatus 700 are substantially the same as the touch sensing apparatus 600 shown in FIG. 6, and related description is therefore omitted here for brevity. The difference between the touch sensing apparatuses 700 and 600 is that a sensing key 720, having a signal receiving component 721, a first sensing block 722 and a reference block 723 included therein, of the touch sensing apparatus 700 is disposed clockwise (or counterclockwise). Thus, when the user triggers the touch event TE on the touch sensing apparatus 700, a processing circuit 710 would determine whether the direction of the touch event TE is a clockwise direction or a counterclockwise direction according to the magnitude and variation of the sensing output Sout. For example, when the magnitude of the sensing output Sout gradually increases due to the touch event TE, the processing circuit determines that the direction of the touch event TE is a clockwise direction.

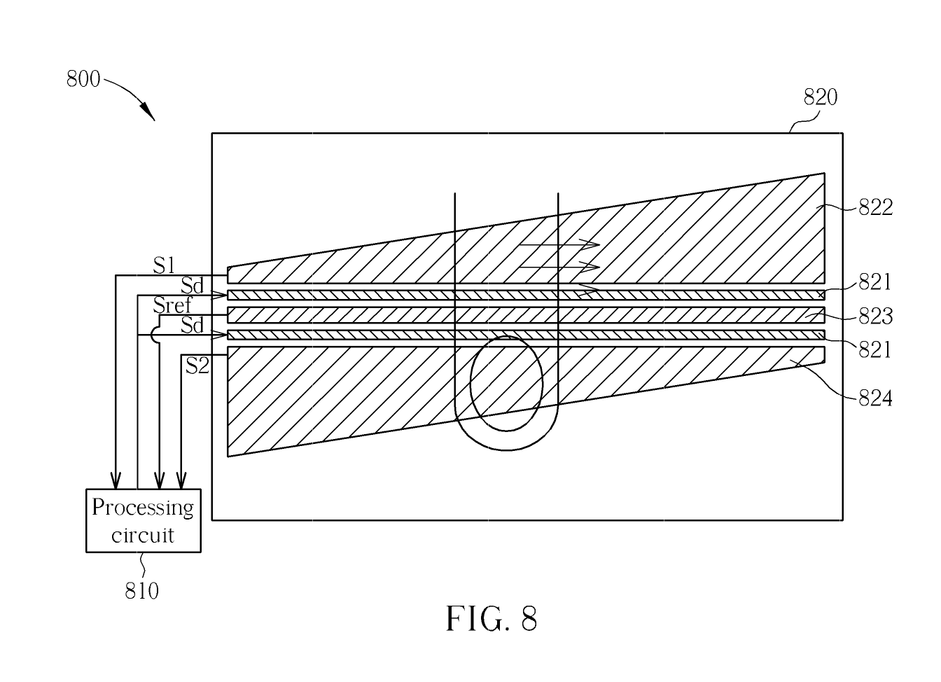

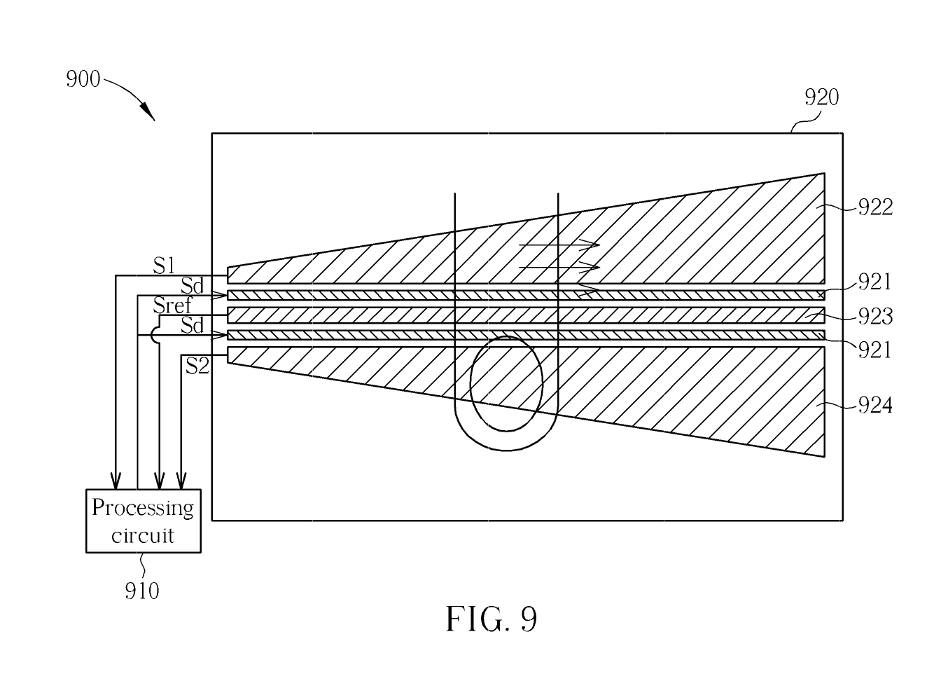

Please refer to FIG. 8 in conjunction with FIG. 6. FIG. 8 is a schematic diagram of a touch sensing apparatus 800 according to another embodiment of the present invention. Functions and structures of the touch sensing apparatuses 800 and 600 are substantially the same, and related description is therefore omitted here for brevity. However, the major difference between the touch sensing apparatuses 800 and 600 is that a sensing key 820 of the touch sensing apparatus 800 further includes a second sensing block 824 for generating a second sensing signal S2, where the second sensing block 824 has different sensing areas in a predetermined direction (e.g. straight line direction) of the touch sensing apparatus 800. In this embodiment, variation directions of the sensing areas of the first sensing block 822 and the second sensing block 824 are opposite to each other, and the processing circuit 810 would generate the sensing output Sout of the sensing key 820 according to the first sensing signal S1 generated by the first sensing block 822, the first sensing signal S2 generated by the second sensing block 824 and the reference signal Sref generated by a reference block 823. For example, Sout1=S1−Sref, Sout2=S2−Sref, and Sout=Sout1−Sout2. With the structure of the touch sensing apparatus 800, the processing circuit 810 can more precisely obtain a contact direction of a touch event. However, in FIG. 8, the structures of the first sensing block 822 and the second sensing block 824 are only illustrated as an embodiment of the present invention. Please refer to FIG. 9, which is a schematic diagram of a touch sensing apparatus 900 according to another embodiment of the present invention. Functions and structures of the touch sensing apparatuses 900 and 800 are substantially the same, and the difference is that areas of a first sensing block 922 and a second sensing block 924 in the touch sensing apparatus 900 are both increasing in the same straight line direction (e.g. from left to right). The processing circuit 910 would generate the sensing output Sout of a sensing key 920 according to the first sensing signal S1 generated by the first sensing block 922, the first sensing signal S2 generated by the second sensing block 924 and the reference signal Sref generated by a reference block 923. For example, Sout1=S1−Sref, Sout2=S2−Sref, and Sout=Sout1+Sout2. Such a structure can achieve the same effect achieved by the touch sensing apparatus 800.

In addition, the structure of touch sensing apparatus 900 and the touch sensing apparatus 800 can be designed in circle/arc clockwise/counterclockwise according to different requirements of use, and these alternative designs all fall in the scope of the present invention.

To sum up, the present invention proposes a touch sensing device using differential mutual capacitance, which utilizes a differential signal to detect a touch event and a contact direction of the touch event. Besides, the present invention may also refer to the contact area size to determine the contact direction of the touch event.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch sensing apparatus, for generating a touch sensing result according to a touch event, the touch sensing apparatus comprising:
at least one sensing key, each sensing key comprising:
a signal receiving component, only used for receiving a driving signal;
a first sensing block, coupled to the signal receiving component, the first sensing block arranged to generate a first sensing signal according to the touch event and the driving signal; and
a reference block, coupled to the signal receiving component, the reference block arranged to generate a reference signal according to the touch event and the driving signal; and
a processing circuit, coupled to the sensing key, the processing circuit arranged to provide the driving signal and receive the first sensing signal and the reference signal, generate a sensing output of the sensing key according to at least the reference signal and the first sensing signal generated by the sensing key, and generate the touch sensing result according to at least the sensing output.

2. The touch sensing apparatus of claim 1, wherein the processing circuit calibrates the first sensing signal based on the reference signal, and accordingly generates the sensing output of the sensing key.

3. The touch sensing apparatus of claim 1, wherein the at least one sensing key comprises a plurality of sensing keys; the plurality of sensing keys are arranged in a predetermined direction of the touch sensing apparatus, and arranged to generate a plurality of sensing outputs according to the touch event; and the processing circuit generates the touch sensing result according to the plurality of sensing outputs.

4. The touch sensing apparatus of claim 3, wherein a plurality of reference blocks respectively corresponding to the plurality of sensing keys are coupled to each other.

5. The touch sensing apparatus of claim 3, wherein a plurality of signal receiving components respectively corresponding to the plurality of sensing keys are coupled to each other.

6. The touch sensing apparatus of claim 3, wherein the predetermined direction is a straight line direction, a clockwise direction or a counterclockwise direction.

7. The touch sensing apparatus of claim 1, wherein the first sensing block has different sensing areas in a predetermined direction of the touch sensing apparatus.

8. The touch sensing apparatus of claim 7, wherein each sensing key further comprises:
a second sensing block, coupled to the signal receiving component, the second sensing block arranged to generate a second sensing signal according to the touch event and the driving signal, the second sensing block having different sensing areas in the predetermined direction; and
the processing circuit further receives the second sensing signal, and generates the sensing output of the sensing key according to the reference signal, the first sensing signal and the second sensing signal generated by the sensing key.

9. The touch sensing apparatus of claim 8, wherein the predetermined direction is a straight line direction, a clockwise direction or a counterclockwise direction.
